(19) United States
(12) Patent Application Publication
(10) Pub. No.: US 2023/0239141 A1
(43) Pub. Date: Jul. 27, 2023

(54) ENCRYPTED COMMUNICATION PROTOCOL FOR NETWORKED HVAC SYSTEMS

(71) Applicant: Carrier Corporation, Palm Beach Gardens, FL (US)

(72) Inventors: Steven Brunjes, Huntington, IN (US); Benjamen D. Baker, New Haven, IN (US)

(21) Appl. No.: 18/160,052

(22) Filed: Jan. 26, 2023

Related U.S. Application Data
(60) Provisional application No. 63/303,794, filed on Jan. 27, 2022.

(51) Int. Cl. H04L 9/08; H04L 9/32

(52) U.S. Cl. CPC H04L 9/0825; H04L 9/0866; H04L 9/0891; H04L 9/3263

(57) ABSTRACT

A system and method for encrypting communication for networked heating, ventilation, and air conditioning (HVAC) devices. A method includes obtaining a list of network devices of a network, requesting a certificate for each network device in the list of network devices of the network, and generating a shared symmetric key for encrypting communication in the network. A method may also include encrypting the shared symmetric key with a public key for each network device in the list of network devices having a valid certificate, transmitting the encrypted shared symmetric key with each network device having a valid certificate, each network device includes a different certificate, and communicating between the master device and the network device using the shared symmetric key.

### CROSS-REFERENCE TO RELATED APPLICATIONS

This application claims the benefit of U.S. Provisional Application No. 63/303,794 filed Jan. 27, 2022, all of which are incorporated herein by reference in their entirety.

### BACKGROUND

The present invention relates to network, and more specifically, to an encrypted communication protocol for networked HVAC systems.

Encryption is used to securely transmit messages over a network. Encryption schemes can include symmetric and asymmetric encryption. Symmetric encryption uses a single network key to encrypt and decrypt messages quickly. Asymmetric encryption uses public and private key pairs to encrypt and decrypt messages. Asymmetric encryption offers increased security however, it is more complex than the symmetric encryption key process. As a result, common asymmetric encryption processes often take longer. Regardless of the type of encryption process utilized, there remains a need for improvements to increase the efficiency of the encryption in way that does not reduce the security of the network.

### BRIEF DESCRIPTION

According to an embodiment, a method for encrypting communication for networked heating, ventilation, and air conditioning (HVAC) system is provided. The method can include obtaining, by a master device, a list of network devices of a network; requesting a certificate for each network device in the list of network devices of the network; and generating a shared symmetric key for encrypting communication in the network. The method can also include encrypting the shared symmetric key with a public key for each network device in the list of network devices having a valid certificate; transmitting the encrypted shared symmetric key with each network device having a valid certificate, wherein each network device comprises a different certificate; and communicating between the master device and the network device using the shared symmetric key.

In addition to one or more of the features described herein, or as an alternative, further embodiments include receiving the certificate for each device in the list of network devices; and validating the certificate for each device to confirm the identity of each network device.

In addition to one or more of the features described herein, or as an alternative, further embodiments include using two or more network devices communicating over the network using the shared symmetric key.

In addition to one or more of the features described herein, or as an alternative, further embodiments include receiving the certificate from a user device, wherein the certificate comprises a time period for authorizing the user device to connect the plurality of network devices.

In addition to one or more of the features described herein, or as an alternative, further embodiments include updating the shared symmetric key to prevent communication using the shared symmetric key after the expiration of the time period.

In addition to one or more of the features described herein, or as an alternative, further embodiments include encrypting communication in the network using the updated shared symmetric key.

In addition to one or more of the features described herein, or as an alternative, further embodiments include using a shared symmetric key that is comprised in a quick response (QR) code.

According to another embodiment, a system for encrypting communication for a networked heating, ventilation, and air conditioning (HVAC) system is provided. The system comprises a master device and a plurality of network devices coupled to the master device. The master device is configured to obtain a list of the plurality network devices of a network; request a certificate for each device in the list of the plurality of network devices of the network; generate a shared symmetric key for encrypting communication in the network; encrypt the shared symmetric key with a public key for each device in the list of plurality of network devices having a valid certificate; transmit the encrypted shared symmetric key to each network device having a valid certificate, wherein each network device comprises a different certificate; and communicate with the network device using the shared symmetric key.

In addition to one or more of the features described herein, or as an alternative, further embodiments include a master device that is configured to receive the certificate for each network device in the list of devices; and validate the certificate for each network device to confirm the identity of each device.

In addition to one or more of the features described herein, or as an alternative, further embodiments include using two or more devices communicating over the network using the shared symmetric key.

In addition to one or more of the features described herein, or as an alternative, further embodiments include a master device that is configured to receive the certificate from a user device, wherein the certificate comprises a time period for authorizing the user device to connect the plurality of network devices.

In addition to one or more of the features described herein, or as an alternative, further embodiments include a master device that is configured to update the shared symmetric key to prevent communication using the shared symmetric key after the expiration of the time period.

In addition to one or more of the features described herein, or as an alternative, further embodiments include a master device that is configured to encrypt communication in the network using the updated shared symmetric key.

In addition to one or more of the features described herein, or as an alternative, further embodiments include a shared symmetric key that is comprised in a quick response (QR) code.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts an exemplary system for encrypting communication for networked heating, ventilation, and air conditioning (HVAC) systems in accordance with one or more embodiments of the disclosure;

FIG. 2 depicts an exemplary network device in accordance with one or more embodiments of the disclosure;

FIG. 3 depicts an exemplary system enabling a user device to connect to the encrypted network in accordance with one or more embodiments of the disclosure;

FIG. 4 depicts an exemplary system that provides a QR code to connect a user device to the encrypted network in accordance with one or more embodiments of the disclosure; and

FIG. 5 depicts a flowchart of an exemplary method for implementing an encryption communication protocol for networked HVAC systems in accordance with one or more embodiments of the disclosure.

### DETAILED DESCRIPTION

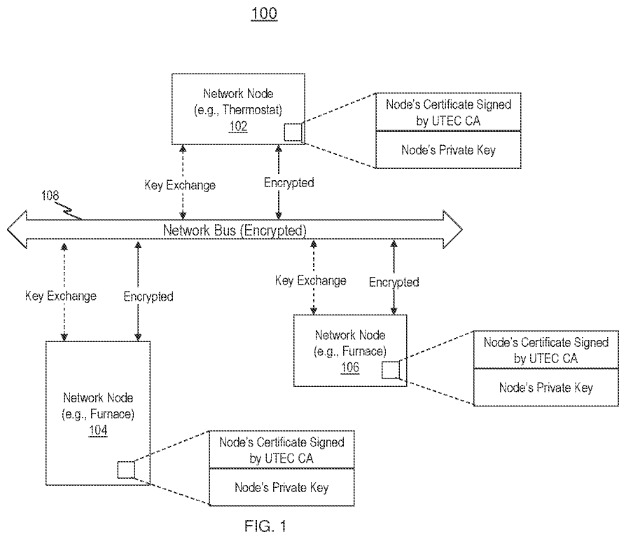

FIG. 1 depicts an exemplary system for performing communication encryption in a network of heating, ventilation, and air conditioning (HVAC) devices. System 100 includes network devices 102, 104, and 106 (which may be referred to herein as network nodes). The networks nodes 102, 104, 106 can include user devices, diagnostic devices, etc. In addition, the network nodes 102, 104, 106 can include HVAC equipment/devices such as thermostats, furnaces, outdoor units, etc. that are operable to be connected over a network with other devices. As shown, each of the network nodes includes a digital certificate that is signed by a certification authority to confirm the identity of each network device. The certificates can be provided between different nodes of the network and used to verify the identity of the party providing the certificate. Each network device 102, 104, 106 stores a private key for decrypting one or more messages prior to obtaining the shared symmetric key from the network. Each network device 102, 104, 106 can be coupled to the other network devices over the network 108 (which may be an encrypted network bus).

The network(s) 108 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In one or more embodiments of the disclosure, any of the network devices 102, 104, 106 can be configured as a master device or master node. In a non-limiting example, the master device can be the thermostat of HVAC system. The master device may perform different tasks than the other network devices. For example, the master device can maintain a list of network devices, nodes, etc. that are connected to the network. Also, the master device may be configured to validate certificates that are used in the network to verify the identity of the network devices/nodes.

The master device can be configured to confirm the authenticity of the node providing the certificate. The master device can be further configured to generate a symmetric key to encrypt the communication traffic on the network. In a non-limiting example, a random hardware number generator can be used to generate the shared symmetric key. It can be appreciated that other network devices can be operated as the master device.

To provide the symmetric key to the network devices, the master device uses each of the network devices' public key to encrypt the symmetric key and provides the symmetric key to the network devices over a key exchange channel. Once all network devices receive the symmetric key, each of the network devices decrypt the encrypted symmetric key using each respective network device's private key to obtain the symmetric key for communicating in the network. Subsequently, the network devices can use the symmetric key to encrypt the data for secure communication over an encrypted channel in the network.

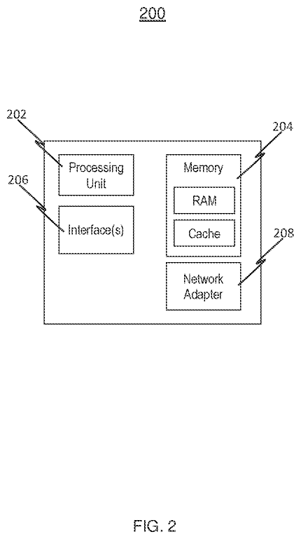

Referring now to FIG. 2, in which an exemplary node 200, representative of any of the network devices of FIG. 1, that may be used to implement the embodiments of the present disclosure is shown. Node 200 is only illustrative and is not intended to suggest any limitation as to the scope of use or functionality of embodiments of the invention described herein.

As shown in FIG. 2, node 200 is shown in the form of a general-purpose computing device. The components of node 200 may include, but are not limited to, one or more processors 202, a memory 204, interface 206, and network adapter 208. In one or more embodiments of the disclosure, the processor 202 can include a processor 202 of a general-purpose computer, special purpose computer, or other programmable data processing apparatus configured to execute instruction via the processor of the computer or other programmable data processing apparatus.

Nodes 200 can include a variety of computer system readable media. Such media may be any available media that is accessible by node 200, and it includes both volatile and non-volatile media, removable and non-removable media. Memory 204 can include computer system readable media. The memory 204 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), etc.). Node 200 may further include other removable/non-removable, volatile/non-volatile computer system storage media. The processor 202 and a memory 204 are configured to carry out the operations for the nodes.

The memory 204 may include one or more program modules (not shown) such as operating system(s), one or more application programs, other program modules, and program data. Each of the operating systems, one or more application programs, other program modules, and program data or some combination thereof, may include an implementation of a networking environment. The program modules generally carry out the functions and/or methodologies of embodiments of the invention as described herein. The node 200 may also include hardware modules such as but not limited to AES128, AES192, AES256, DES, 3DES, MD5, SHA-1, and SHA-256 to perform the encryption process. It can be appreciated that other generic and/or specialized hardware modules can be included in the node 200 and is not limited by the examples provided herein.

Node 200 may also communicate with one or more external devices through the interface 206 such as a keyboard, a pointing device, a display, etc.; one or more devices that enable a user to interact with node 200; and/or any devices (e.g., network card, modem, etc.) that enable node 200 to communicate with one or more other computing devices.

Still yet, node 200 can communicate with one or more networks such as a local area network (LAN), a general wide area network (WAN), and/or a public network (e.g., the Internet) via network adapter 208. As depicted, network adapter 208 communicates with the other components of node 200. It should be understood that although not shown, other hardware and/or software components could be used in conjunction with node 200.

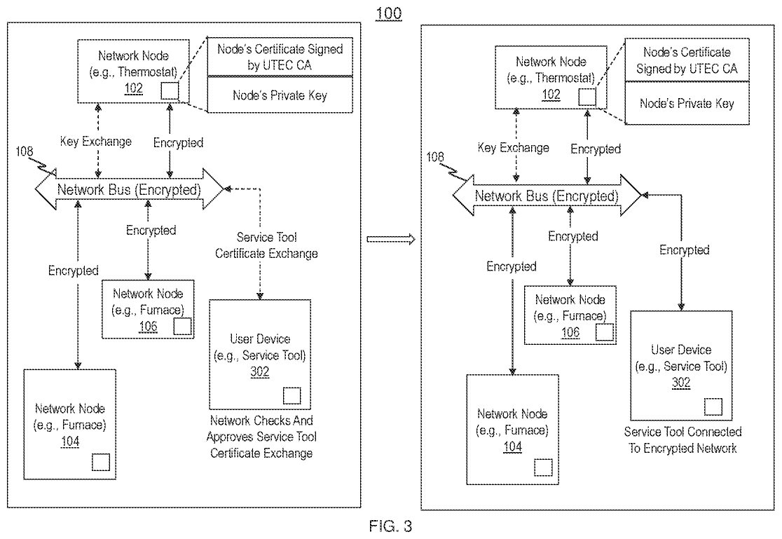

FIG. 3 depicts a system 100 where a user device 302 connects to the network 108 in accordance with one or more embodiments of the disclosure. An example user device 302 may include a technician tool or diagnostic device. In one some embodiments of the disclosure, the user device 302 can be configured to generate a temporary certificate for the system needing service. The temporary certificate can be generated by the user inputting the period of time the user intends to service the system. In other embodiments of the disclosure, the temporary certificate can be generated external to the user device 302, such as by a management utility (not shown), and provided to the user device 302.

The user/user device 302 provides the certificate to a master device of the system 100. The master device can be configured to add the network device to the list of approved network devices. Once approved, the system can provide the symmetric key to the user device 302, using the techniques described herein, to allow the communication and traffic within the network to be decoded. Upon expiration of the time period of the certificate, the master device can update the symmetric key without updating the user/user device which effectively blocks any further communication with the user/user device because the certificate has expired.

This technique enables only authorized service technicians/devices to access the protected HVAC network for a limited time period that the service for the HVAC equipment has been authorized.

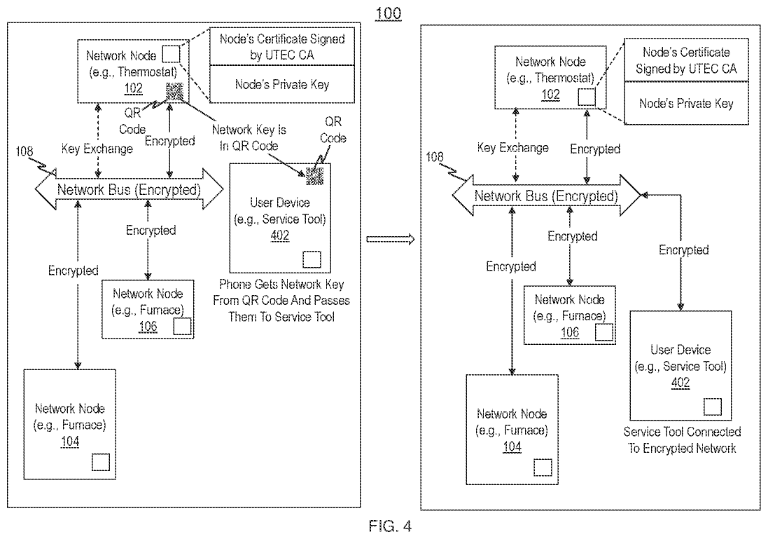

FIG. 4 depicts a system 100 using a quick response (QR) code to access the encrypted network. In one or more embodiments of the disclosure, the network encryption key or symmetric can be provided to a user/user device 402 using a QR code. It can be appreciated that other visual encoding codes can be used and is not limited to the QR code shown in FIG. 4. The service tool of the user device 402 can be configured to read the QR code from the network device 102. At the completion of the service session, the network key may be changed to prevent unauthorized access by the user/service technician.

The techniques described herein enable the network key to be transferred to the technician while reducing the ability of an eavesdropper from gaining access to the network. Also, since the network key is encoded in the QR code, the network key is not directly visible to others.

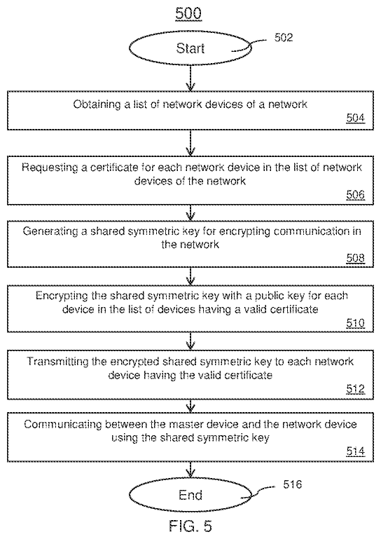

FIG. 5 depicts a flowchart of a method 500 for encrypting communication for network devices in an HVAC network in accordance with one or more embodiments of the disclosure. The method 500 can be implemented in any of the systems such as that shown in FIGS. 1-4. The method 500 begins at block 502, and proceeds to block 504 where the master device obtains a list of network devices of a network. The master device can be configured to poll or query each of the network devices connected to the network, or the network devices can be configured to periodically broadcasts its identifier to the master device. In addition, a combination of the techniques may be implemented to obtain a list of the network devices. At block 506, the master device requests a certificate for each network device in the list of network devices of the network.

At block 508, the master device generates a shared symmetric key for encrypting communication in the network. In one or more embodiments of the disclosure, the master device can be configured to generate a shared symmetric network key using a random number generator. It can be appreciated that other techniques can be used to generate the symmetric key for encryption.

At block 510, the master device encrypts the shared symmetric key with a public key for each network device in the list of network devices having a valid certificate. At block 512, the master device transmits the encrypted shared symmetric key to each network device having the valid certificate. At block 514, communicating between the master device and the network devices begins using the shared symmetric key. In one or more embodiments of the disclosure, two or more network devices can be configured to use the same shared symmetric key to communicate between all of the network devices.

The method 500 ends at block 516. The process flow diagram of FIG. 5 is not intended to indicate that the operations of the method 500 are to be executed in any particular order, or that all of the operations of the method 500 are to be included in every case. Additionally, the method 500 can include any suitable number of additional operations.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method for encrypting communication for networked heating, ventilation, and air conditioning (HVAC) system, the method comprising:
obtaining, by a master device, a list of network devices of a network;
requesting a certificate for each network device in the list of network devices of the network;
generating a shared symmetric key for encrypting communication in the network;
encrypting the shared symmetric key with a public key for each network device in the list of network devices having a valid certificate;
transmitting the encrypted shared symmetric key with each network device having a valid certificate, wherein each network device comprises a different certificate; and
communicating between the master device and the network device using the shared symmetric key.

2. The method of claim 1, further comprising:
receiving the certificate for each device in the list of network devices; and
validating the certificate for each device to confirm the identity of each network device.

3. The method of claim 1, wherein two or more network devices of the network devices communicate over the network using the shared symmetric key.

4. The method of claim 1, further comprising receiving the certificate from a user device, wherein the certificate comprises a time period for authorizing the user device to connect the plurality of network devices.

5. The method of claim 4, further comprising updating the shared symmetric key to prevent communication using the shared symmetric key after the expiration of the time period.

6. The method of claim 5, further comprising encrypting communication in the network using the updated shared symmetric key.

7. The method of claim 1, wherein the shared symmetric key is comprised in a quick response (QR) code.

8. A system for encrypting communication for a networked heating, ventilation, and air conditioning (HVAC) system, the system comprising:
a master device;
a plurality of network devices coupled to the master device, wherein the master device is configured to:
obtain a list of the plurality network devices of a network;
request a certificate for each device in the list of the plurality of network devices of the network;
generate a shared symmetric key for encrypting communication in the network;
encrypt the shared symmetric key with a public key for each device in the list of plurality of network devices having a valid certificate;
transmit the encrypted shared symmetric key to each network device having a valid certificate, wherein each network device comprises a different certificate; and
communicate with the network device using the shared symmetric key.

9. The system of claim 8, wherein the master device is configured to:
receive the certificate for each network device in the list of devices; and
validate the certificate for each network device to confirm the identity of each device.

10. The system of claim 8, wherein two or more devices of the plurality of network devices communicate over the network using the shared symmetric key.

11. The system of claim 8, wherein the master device is configured to receive the certificate from a user device, wherein the certificate comprises a time period for authorizing the user device to connect the plurality of network devices.

12. The system of claim 11, wherein the master device is configured to update the shared symmetric key to prevent communication using the shared symmetric key after the expiration of the time period.

13. The system of claim 12, wherein the master device is configured to encrypt communication in the network using the updated shared symmetric key.

14. The system of claim 8, wherein the shared symmetric key is comprised in a quick response (QR) code.
